(19) United States
(12) Patent Application Publication
(10) Pub. No.: US 2025/0137863 A1
(43) Pub. Date: May 1, 2025

(54) TEST BENCHES TO CHECK CORRECT OPERATION OF TORQUE WRENCHES FITTED WITH DEVICES FOR POSITIONING REACTION POINTS OF THE TORQUE WRENCHES

(71) Applicant: Atlas Copco Industrial Technique AB, Stockholm (SE)

(72) Inventor: Francesco SALAMONE, Paderno Dugnano (MI) (IT)

(21) Appl. No.: 18/835,323

(22) PCT Filed: Feb. 21, 2023
(86) PCT No.: PCT/IB2023/051565

§ 371 Date: Aug. 1, 2024

(30) Foreign Application Priority Data
Feb. 22, 2022 (IT) 102022000003293

(51) Int. Cl. G01L 25/00

(52) U.S. Cl. CPC G01L 25/003

(57) ABSTRACT

A test bench for checking correct operation of torque wrenches to be tested may include: at least one calibration station for a torque wrench, wherein the at least one calibration station includes a transducer, including a rotating head, configured to couple with a tool head of the torque wrench so that the tool head and the rotating head rotate in unison; an electronic processing unit configured to control the transducer according to predetermined tightening programs consistent with the torque wrenches to be tested; and a locking mechanism of the torque wrench, configured to lock a handle of the torque wrench when the tool head is coupled to the rotating head, wherein the locking mechanism includes an elongated guide, on which a slide moves longitudinally with respect to the handle of the torque wrench, wherein the elongated guide includes reaction bars that limit movement by the handle of the torque wrench.

The present invention refers to a test bench to check the correct operation of a torque wrench fitted with a device for positioning the reaction point of the wrench.

Such benches are usually of two types. A first type comprises a transducer that couples to the tool head of the wrench which is a brake adapted to simulate the conditions of a joint; for example it simulates the tightening of a bolt or a screw, having on its head a hexagonal nut or screw shape. This bolt is tightened by the tightening instrument, in particular by the torque wrench to be tested. The tightening carried out by the wrench is simulated by manually rotating or with special automatic mechanisms the wrench itself, simulating the tightening by an operator. A second type of test is carried out using a transducer which is a motorized transducer (or static cell) which has on its head a hexagonal nut or screw shape in general a shape adapted to couple to the tool head of the wrench. The test is carried out by rotating the aforementioned head of the transducer through the motor and at the same time by keeping the wrench in a fixed position with a special locking mechanism.

The bench comprises an electronic computer that controls the electrical or hydraulic circuit of the brake or the motorized transducer and that comprises an adequate driving program stored on it. The driving program, in the bench of the first type once an operator has selected the brake to be used for the test, is able to progressively increase the braking capacity of the brakes and rotating the wrench until reaching the complete stop of the rotation of the wrench itself. Each brake is equipped with measuring transducers connected to the electronic processing unit of the bench, which are able to detect the braking torque that the wrench exerts on the brake itself during tightening.

Such a test bench is described in patent application WO2019111146. In the second type of bench, the one provided with at least one motorized transducer, the torque wrench, is coupled with it, so that by locking the wrench handle in the special locking mechanism and by rotating the head of the transducer by means of such suitable driving program with which the wrench is coupled, the test is carried out statically without rotating the wrench itself. In fact, the head of the transducer simply puts the wrench in tension by applying a torque, the wrench itself does not rotate due to the presence of the locking mechanism.

The present invention applies to a bench that can have different test modules, both of the first and of the second type. In the same bench there may be brakes adapted to carry out dynamic tests in which the wrench rotates and motorized transducers adapted to carry out static tests in which the wrench does not rotate.

According to the length of the wrench as a whole, the locking mechanism of the wrench handle, called the reaction bar, must be able to move longitudinally, so that the clamp of the bar is positioned substantially in correspondence with the wrench handle. Manual systems are known in the state of the art in which a lever is provided to be operated manually to unlock the sliding of the reaction bar, to always position it manually and then lock it again with the same lever.

The Applicant has noted that such systems may sometimes be inaccurate, even if they are accompanied by an electronic system that guides the user's operations. In addition, for such manual systems, the residual risk of forgetting to tighten the locking lever must be weighed up.

The present invention proposes a test bench to check the correct operation of a torque wrench fitted with a device for positioning the reaction point of the wrench which is substantially automatically controlled.

An aspect of the present invention concerns a test bench having the characteristics of claim 1.

Further features of the present invention are contained in the dependent claims.

The characteristics and advantages of the present invention will become more apparent from the following description of an embodiment of the invention, provided by way of non-limiting example, with reference to the schematic attached drawings, wherein:

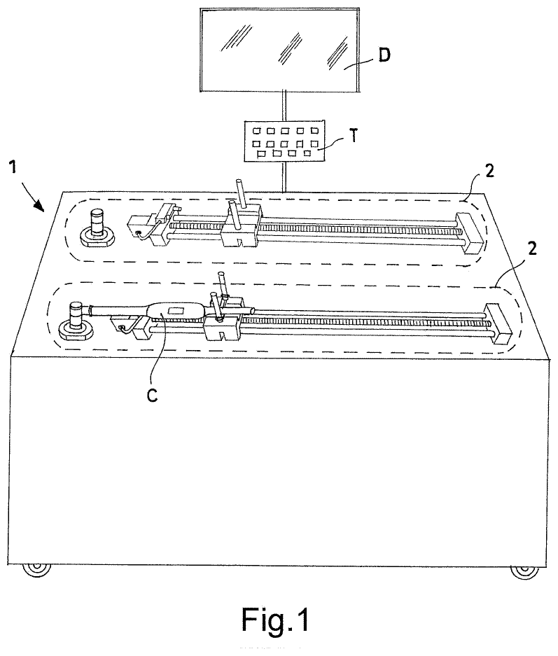

FIG. 1 illustrates a schematic view of the test bench according to the present invention;

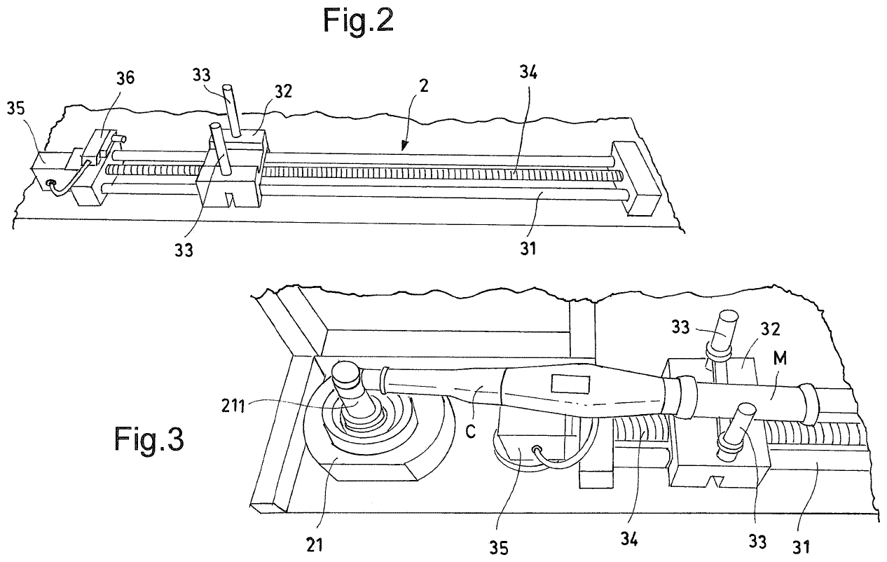

FIG. 2 illustrates the locking mechanism of the wrench handle of the bench of FIG. 1;

FIG. 3 illustrates an enlarged detail of the bench of FIG. 1.

With reference to the aforementioned figures, the test bench 1 for checking the correct operation of a torque wrench according to the illustrated embodiment of the present invention comprises at least one calibration station 2 for a torque wrench C comprising a motorized transducer 21 having a rotating head 211 adapted to be coupled to the tool head of the torque wrench to be analysed, so that the tool head of the wrench and the head of the transducer rotate in unison. The coupling typically occurs as the head has a hexagonal or screw nut shape.

This motorized transducer simulates the conditions of a joint; for example, it simulates the tightening of a bolt or a screw, and is able to rotate the head coupled to the torque wrench by applying a predetermined load (exerted torque). The bench also comprises an electronic processing unit, preferably equipped with a suitable display D and user interface T that controls the load exerted by the transducer according to predetermined tightening programs depending on the type of wrench to be tested. Said station further comprises a locking mechanism 3 of the handle of the wrench.

In the embodiment of the bench in which the rotating motorized transducer is present, the locking mechanism is static and when the head of the wrench is coupled to the head of the transducer it defines a reaction point; such mechanism comprises an elongated guide 31 on which a slide 32 provided with reaction bars 33 that delimit the handle M of the wrench slides and prevent its rotation when the transducer rotates during the test.

In the embodiment (not illustrated) of the bench in which brakes are present, said calibration station 2 for a torque wrench C comprises a brake having a head with which the wrench is coupled and the locking mechanism 3 of the wrench handle is rotating about the rotation axis of the head of the break. This locking mechanism can rotate operated manually or by means of special automatic mechanisms. In such an embodiment the elongated guide 31, on which the slide 32 provided with reaction bars 33 that delimit the handle M slides, rotates around the rotation axis of the brake head. In this case the test is dynamic.

In the embodiment illustrated on the bench 1, which is by way of example shaped like a trolley provided with wheels,
the calibration stations are two side by side on the upper surface of the trolley. Equivalently, depending on the size of the trolley, the number of the calibration stations may be greater or lower and may have the transducer in one case and the brake in another.

According to the present invention the longitudinal positioning of the slide in correspondence with the handle is automatic and is controlled by said electronic processing unit of the bench, based on the recognition of the characteristics of the wrench.

For the purposes of the present invention, by characteristics of the wrench it is meant the dimensions thereof, the length of the handle, the tightening characteristics, such as the point of application of the force on the handle, capacity, etc. . . .

This recognition can be carried out manually by an operator for example through the user interface T with the insertion of the wrench model, or automatically by means of suitable electronic detection means with which the bench is provided (for example through an RFID transponder on the wrench, NFC coupling technologies, etc. . . . ).

The movement of the slide is preferably achieved by means of a worm (or ball recirculation) mechanism, which converts the rotary motion of a screw shaft 34 arranged along the entire length of the guide 31 in the linear motion of the slide 32.

The rotation of the shaft 34 occurs through a motor 35 (for example stepper motor) controlled by the electronic processing unit. Advantageously, the guide 31 is equipped at its end close to the transducer with limit switch devices 36 monitored by said processing unit.

The electronic processing unit of the bench imparts a controlled rotation (predetermined torque) to the transducer engaged with the tool head of the wrench and reads through the sensors present on the wrench itself, which is connected with the processing unit of the bench, the corresponding values of the torque it measures. From the comparison between the data given and those measured, the test is carried out on the instrument to understand, for example, if the instrument is calibrated or requires maintenance, repair interventions, etc.

Through the use of a calibration management software, based on the type of wrench to be calibrated, the slide is sent to a certain position. In this way, it is not necessary to carry out this operation manually with the risk of errors.

In fact, the possibility of positioning a “small” capacity wrench by launching a calibration program for a larger capacity wrench, with a consequent yielding or breakage of the wrench itself is avoided. With automatic positioning the reaction bars would be in a position where it would be impossible to position the small wrench.

In addition to the use described above, the automatic positioning of the reaction bars allows the processing unit to change the positioning of the slide and of the bars themselves during the calibration of a same wrench.

In this way it is possible to apply the load in two different points of the handle, making in an exemplary and non-limiting way possible the calibration of wrenches provided with double bridge without manual intervention and the repositioning in 2 points of the handle required by ISO6789 standard.

1. A test bench for checking correct operation of a torque wrench, the test bench comprising:
at least one calibration station for the torque wrench, wherein the at least one calibration station comprises a transducer having a rotating head configured to couple with a tool head of the torque wrench, so that the tool head of the torque wrench and the rotating head of the transducer to rotate in unison;
an electronic processing unit configured to control the transducer according to predetermined tightening programs according to a type of torque wrench to be tested; and
a locking mechanism of a handle of the torque wrench, configured to lock the handle of the torque wrench when the tool head of the torque wrench is coupled to the rotating head of the transducer, wherein the locking mechanism comprises an elongated guide, on which a slide slides longitudinally with respect to the handle of the torque wrench, wherein the elongated guide is equipped with reaction bars that delimit movement by the handle of the torque wrench;
wherein the electronic processing unit automatically controls longitudinal positioning of the slide in correspondence with the handle of the torque wrench by recognizing characteristics of the torque wrench.

2. The test bench of claim 1, wherein the transducer is a motorized transducer whose rotating head rotates the torque wrench by applying a torque, and
wherein the locking mechanism is static and defines a reaction point where the reaction bars prevent rotation of the torque wrench.

3. The test bench of claim 1, wherein the transducer is a brake having a head with which the torque wrench is coupled and the locking mechanism of the wrench handle of the torque wrench is rotating, and
wherein the elongated guide, on which the slide slides, rotates around a rotation axis of the head of the brake.

4. The test bench of claim 1, wherein the recognizing of the characteristics of the torque wrench can be done manually by an operator or automatically using electronic detection of the test bench.

5. The test bench of claim 1, wherein the electronic processing unit comprises:
a display; and
a user interface.

6. The test bench of claim 1, wherein movement of the slide is achieved using a worm or ball recirculation mechanism, which converts rotary motion of a screw shaft along an entire length of the elongated guide into linear motion of the slide.

7. The test bench of claim 6, wherein rotation of the screw shaft occurs through a motor controlled by the electronic processing unit.

8. The test bench of claim 1, wherein the elongated guide is equipped, at an end close to the transducer, with limit switch devices monitored by the electronic processing unit.

9. The test bench of claim 1, wherein the test bench is shaped like comprises a trolley with wheels, and
wherein the at least one calibration station comprises two calibration stations side-by-side on an upper surface of the trolley.

10. The test bench of claim 2, wherein the electronic processing unit:
imparts a controlled rotation with predetermined tightening torque to the transducer engaged with the tool head of the torque wrench;
reads measured torque data of the torque wrench through sensors present on the torque wrench;
compares imparted torque data with the measured torque data; and
determines if the torque wrench is calibrated or requires interventions.

11. The test bench of claim 3, wherein the electronic processing unit:
increases a braking capacity of the brake during the rotation of the torque wrench;
reads, through sensors present on the torque wrench, measured torque data;
compares given torque data with the measured torque data; and
determines if the torque wrench is calibrated or requires interventions.

12. A test bench for checking correct operation of torque wrenches to be tested, the test bench comprising:
at least one calibration station for a torque wrench, wherein the at least one calibration station comprises a transducer, comprising a rotating head, configured to couple with a tool head of the torque wrench so that the tool head of the torque wrench and the rotating head of the transducer rotate in unison;
an electronic processing unit configured to control the transducer according to predetermined tightening programs consistent with the torque wrenches to be tested; and
a locking mechanism of the torque wrench, configured to lock a handle of the torque wrench when the tool head of the torque wrench is coupled to the rotating head of the transducer, wherein the locking mechanism comprises an elongated guide, on which a slide moves longitudinally with respect to the handle of the torque wrench, wherein the elongated guide comprises reaction bars that limit movement by the handle of the torque wrench;
wherein the electronic processing unit automatically controls longitudinal movement of the slide with respect to the handle of the torque wrench by recognizing characteristics of the torque wrench.

13. The test bench of claim 12, wherein the electronic processing unit comprises:
a display; and
a user interface.

14. The test bench of claim 12, wherein the locking mechanism is static during testing of the torque wrench.

15. The test bench of claim 12, wherein the locking mechanism is dynamic during testing of the torque wrench.

16. The test bench of claim 15, wherein when the locking mechanism is dynamic during testing of the torque wrench, the locking mechanism is rotated manually by an operator.

17. The test bench of claim 15, wherein when the locking mechanism is dynamic during testing of the torque wrench, the locking mechanism is rotated automatically.

18. The test bench of claim 12, wherein the reaction bars limit linear horizontal movement by the handle of the torque wrench.

19. The test bench of claim 12, wherein the reaction bars limit rotational horizontal movement by the handle of the torque wrench.

20. The test bench of claim 12, wherein when the electronic processing unit automatically controls the longitudinal movement of the slide with respect to the handle of the torque wrench, the test bench is configured to apply load at different points of the handle of the torque wrench without manual intervention by an operator.
